(19) United States
(12) Patent Application Publication
(10) Pub. No.: US 2010/0053108 A1
(43) Pub. Date: Mar. 4, 2010

(54) PORTABLE DEVICES AND CONTROLLING METHOD THEREOF

(76) Inventors: Jung-Guk CHAE, Osan (KR); Moo-Rok CHOI, Hwaseong (KR); Na-Ri LEE, Seoul (KR)

Correspondence Address: BIRCH STEWART KOLASCH & BIRCH, PO BOX 747, FALLS CHURCH, VA, 22040-0747, US

(21) Appl. No.: 12/549,848

(22) Filed: Aug. 28, 2009

(30) Foreign Application Priority Data
Sep. 1, 2008 (KR) 10-2008-0086009
Sep. 1, 2008 (KR) 10-2008-0086047

(51) Int. Cl. G06F 3/041; G09G 5/00

(52) U.S. Cl. 345/173; 345/3.1

(57) ABSTRACT

A portable electronic device including a first input/output unit including a monostable display element and configured to reproduce multimedia content, a second input/output unit a bistable display element and configured to reproduce an electronic document, a first controller configured to control the first input/output unit, a second controller configured to control the second input/output unit, a memory unit configured to store the multimedia content and the electronic document, and a control unit configured to selectively control the first controller to reproduce the multimedia content on the first input/output unit, and to control the second input/output unit to reproduce the electronic document on the second input/output unit.

### CROSS-REFERENCE TO RELATED APPLICATION

Pursuant to 35 U.S.C. §119(a), this application claims the benefit of earlier filing date and right of priority to Korean Application Nos. 10-2008-0086009 and 10-2008-0086047 filed on Sep. 1, 2009, the contents of which are incorporated by reference herein in its entirety. This application is also related to U.S. application Ser. No. ______ (Attorney Docket No. 0630-3887PUS1), the entire contents of which are also incorporated by reference in their entirety.

### BACKGROUND OF THE INVENTION

1. Field of the Invention

The present invention relates to a portable electronic device having two input/output units and a method of reproducing content thereof.

2. Background of the Invention

Portable electronic devices are now very popular and provide many features. For example, portable electronic devices are used with home appliances, as mobile terminals, as broadcasting terminals, etc. For instance, mobile communication terminals provide various functions such as allowing users to view DMB (Digital Multimedia Broadcasting), play MP3 music files, take pictures, and the like in addition to typical communication functions such as audio communication. Users can also send and receive text messages, access the Internet, etc.

The portable electronic devices also include relatively small displays that display various information such as information downloaded from a server, information input by a user, and the like. In addition, the display unit included in the portable electronic device includes a CRT (cathode ray tube) display device and a flat panel display device such as LCD (liquid crystal display), PDP (plasma display panel), and the like. Some terminals also include a relatively new technology referred to as electronic paper (e-paper) displays. In more detail, the electronic paper displays includes organic thin-film transistors formed on a plastic substrate and a reflective bistable display element is formed thereon. However, the display unit included with the portable electronic device is limited in nature, making it inconvenient for the user.

### SUMMARY OF THE INVENTION

Accordingly, one object of the present invention is address the above-noted and other problems.

Another object of the present invention is to provide a portable electronic device and corresponding control method in Which when a specific object of the contents included in electronic document is selected while reproducing the electronic document through an input/output unit, the hyperlinked content for the selected object is reproduced through another input/output unit.

Yet another object of the present invention is to provide a portable electronic device and corresponding control method in which when a content file connected to a hyperlink object is selected is not stored in a portable electronic device among the contents of the electronic document reproduced through an input/output unit, the content file is downloaded from a server and provided to a user through the other input/output unit.

To achieve these and other advantages and in accordance with the purpose of the present invention, as embodied and broadly described herein, the present invention provides in one aspect a portable electronic device including a first input/output unit including a monostable display element and configured to reproduce multimedia content, a second input/output unit including a bistable display element and configured to reproduce an electronic document, a first controller configured to control the first input/output unit, a second controller configured to control the second input/output unit, a memory unit configured to store the multimedia content and the electronic document, and a control unit configured to selectively control the first controller to reproduce the multimedia content on the first input/output unit, and to control the second input/output unit to reproduce the electronic document on the second input/output unit.

In another aspect, the present invention provides a method of controlling a portable electronic device, and which includes controlling, via a first controller, a first input/output unit including a monostable display element for reproducing multimedia content; controlling, via a second controller, a second input/output unit including a bistable display element for reproducing an electronic document; storing the multimedia content and the electronic document in a memory unit of the portable electronic device; and selectively controlling, via a control unit, the first controller to reproduce the multimedia content on the first input/output unit and the second input/output unit to reproduce the electronic document on the second input/output unit.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating a portable electronic device according to an embodiment of the present invention;

FIG. 2 is an overview of a display screen illustrating one input/output unit in a portable electronic device according to an embodiment of the present invention;

FIG. 3 is an overview of a display screen illustrating another input/output unit in a portable electronic device according to an embodiment of the present invention;

FIG. 4 is a flow chart illustrating a method of reproducing content in a portable electronic device according to a first embodiment of the present invention;

FIG. 5 is a flow chart illustrating a method of reproducing content in a portable electronic device according to a second embodiment of the present invention;

FIG. 6 is a flow chart illustrating a method of reproducing content in a portable electronic device according to a third embodiment of the present invention; and

FIG. 7 is a flow chart illustrating a method of reproducing content in a portable electronic device according to a fourth embodiment of the present invention.

### DETAILED DESCRIPTION OF THE INVENTION

Hereinafter, a preferred embodiment of a portable electronic device according to the present invention, as stated above, will be described in detail with reference to the accompanying drawings.

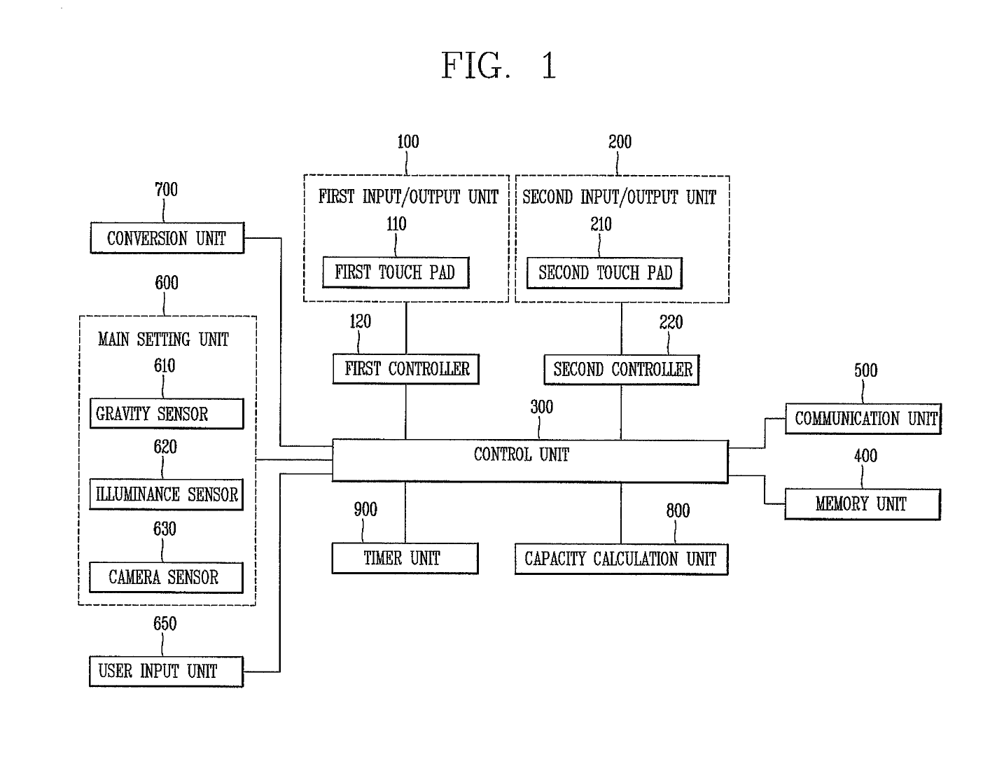

FIG. 1 is a block diagram showing a portable electronic device according to an embodiment of the present invention. As shown, the portable electronic device includes a first input/output unit 100 and a second input/output unit 200. The first input/output unit 100 and the second input/output unit 200 also respectively include a first touch pad 110 and a second touch pad 210. Further, in this embodiment, the first input/output unit 100 includes a monostable display element, and the second input/output unit 200 includes a bistable display element. In another embodiment, the first input/output unit 100 can include a bistable display element, and the second input/output unit 200 can include a monostable display element.

Further, the monostable and bistable display elements are classified by a transmissive state when an electric field is removed. In more detail, the monostable method is a display method in which when an electric field is removed, only one transmissivity is shown at all times regardless of the electric field signal that has been applied. On the other hand, the bistable method is a display method in which when an electric field is removed, two kinds of transmissivities such as black and white are shown according to the electric field signal that has been applied.

For instance, the monostable display element includes and LCD (liquid crystal display), PDP (plasma display panel), and the like, and the bistable display element includes e-paper or electronic paper. Further, the electronic paper has an advantage of consuming low power by maintaining the image as it is even when there is no external signal input. In addition, the first input/output unit 100 and second input/output unit 200 receive a video signal from a first controller 120 and a second controller 220, respectively, to reproduce a video or moving image. The first controller 120 and second controller 220 also convert the data output from a control unit 300 into a video signal suitable for display, and transmit the converted data to the first input/output unit 100 and second input/output unit 200, respectively.

Further, the first input/output unit 100 may include an element for displaying a video signal having a higher frame rate than that of the second input/output unit 200. For instance, the first input/output unit 100 receives a video signal from the first controller 120 to reproduce multimedia content, and the second input/output unit 200 receives a video signal from the second controller 220 to reproduce the multimedia content related information or an electronic document. In addition, the multimedia content file, multimedia content related information data, and electronic document are stored in a memory unit 400. The memory unit 400 can be a nonvolatile memory capable of writing or erasing data. For instance, the memory unit 400 can include any one of EEPROM (Electrically Erasable Programmable Read Only Memory), Flash Memory, PRAM (Phase-change Random Access Memory), FRAM (Ferro-electric RAM), and MRAM (Magneto-resistive RAM).

When the first input/output unit 100 reproduces the multimedia content, the control unit 300 detects the multimedia content related information data and transmits the detected data the second controller 220. For instance, the control unit 300 can detect a file name of the multimedia content to detect the related information data from the memory unit 400. Further, the related information data transmitted to the second controller 220 by the control unit 300 is determined based on a kind of the multimedia content file.

In other words, if the multimedia content file is a music file, then the related information can include at least one or more of ID3 tag information, lyric information, and related article information. For instance, when music is reproduced by the first input/output unit 100, information such as title, composer, singer, and the like, of the music can be displayed by the second input/output unit 200. Further, the control unit 300 can detect information such as the title, composer, and singer, etc., from the song commentary information included in the ID3 tag information. In addition, journal article information such as lyric information, music chart, broadcast appearance, etc. is displayed on the second input/output unit 200.

Furthermore, if the multimedia content file is a video file, then the related information can include at least one or more of subtitle information, film information, and related article information. For instance, when a film is reproduced by the first input/output unit 100, film information such as the title, producer, actor or actress, synopsis, etc. of the film, as well as subtitle information, is displayed by the second input/output unit 200. In addition, journal article information such as a film chart, number of audience, or the like can also be displayed on the second input/output unit 200.

Moreover, if the multimedia content file is an image file, then the related information can include at least one or more of EXIF (exchangeable image file format) information and user input information. For instance, when a photo is reproduced by the first input/output unit 100, EXIF information such as camera and lens information, a capture date, an exposure time, whether or not the flash is used, etc. of the photo can be detected and displayed on the second input/output unit 200. In addition, user input information including specific messages received from a user can be displayed on the second input/output unit 200.

Also, when the multimedia content is being reproduced through the first input/output unit 100, the control unit 300 detects the related information data from the memory unit 400 and transmits the data to the second controller 220. Further, the second controller 220 sequentially accumulates the related information data received from the control unit 300 to generate a video signal. In addition, sequentially accumulating the related information data means to sequentially reproduce a plurality of multimedia contents through the first input/output unit 100, or when the related information data is constituted by a plural number and sequentially detected, to cumulatively record by sequentially displaying from the related information data which has been initially detected to the related information data which has been finally detected.

For instance, if the multimedia content file is a music file, then the control unit 300 detects information such as music lyrics or the like from the memory unit 400 and transmits the detected information to the second controller 220, and the second controller 220 sequentially accumulates the related information data for sequentially displaying information such as music lyrics or the like that has been received from the control unit 300 through the second input/output unit 200.

Further, the video signal generated by using the related information data, which has been sequentially accumulated, is transmitted to the second input/output unit 200, and the second input/output unit 200 reproduces the related information as a type of an electronic document. In addition, the related information generated as a type of electronic document can be sequentially displayed on a page, or sequentially displayed on a plurality of pages by constructing each page respectively.

Furthermore, when a user input to a hyperlink object included in the electronic document is received while the electronic document is reproduced by the second input/output unit, the control unit 300 detects the link object content connected to the hyperlink object and transmits the detected link object and any needed corresponding information to the second controller 220. Further, the electronic document means the data having a document format which is written in an electronic form to be transmitted, received, or stored. Thus, if an electronic document such as electronic press or the like is reproduced by the second input/output unit 200, and when a hyperlink object displayed in any one format of text, image, background or underline attribute included in the electronic press is selected by a user, the first input/output unit 100 reproduces the link object content connected to the hyperlink object selected by the user.

In addition, the link object content includes any one or more of text, image, audio, and video data corresponding to the hyperlink object. For instance, when a user selects a specific word in an electronic document reproduced by the second input/output unit 200, the first input/output unit 100 reproduces an image or video content related to the selected word. Therefore, in the portable electronic device according to an embodiment of the present invention, the first input/output unit 100 can reproduce a color image that cannot be reproduced in the second input/output unit 200, which is provided with a black and white screen such as an electronic paper. Furthermore, there is an advantage that the first input/output unit 100 can reproduce video content, which is not reproducible in the second input/output unit 200 where only a video signal having a relatively low frame rate can be displayed.

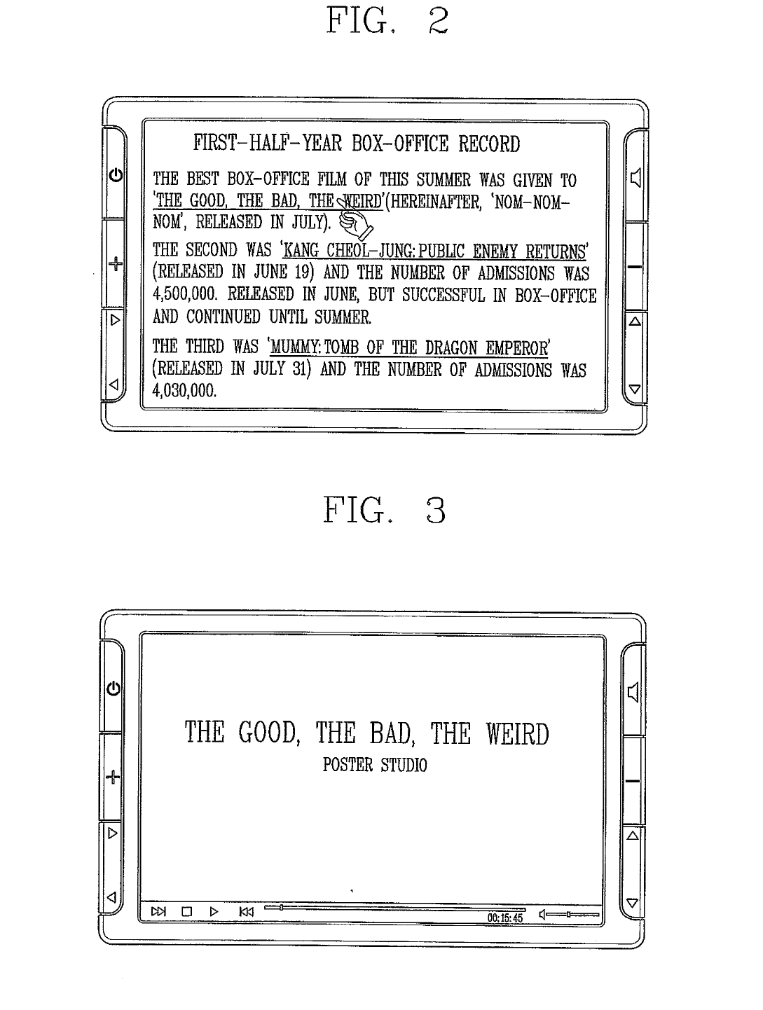

Next, FIGS. 2 and 3 are overviews of the second input/output unit 200 and the first input/output unit 100, respectively, in a portable electronic device according to a concrete embodiment of the present invention. As shown in FIG. 2, the second input/output unit 200 reproduces an electronic document. Further, the reproduced electronic document includes a hyperlink object. For instance, as illustrated in FIG. 2, the hyperlink object can be displayed using an “underline” attribute among text that is included in the contents of the electronic document. Further, as shown in FIG. 3, when the hyperlink object is selected by a user, the first input/output unit 100 reproduces the content subject to the link connected to the selected hyperlink object.

In addition, the first input/output unit 100 in FIG. 3 outputs a video signal having a relatively higher frame rate than that of the second input/output unit 200. For instance, as illustrated in FIG. 3, the first input/output unit 100 reproduces the content subject to the link corresponding to the hyperlink object selected by a user. In other words, the first input/output unit 100 reproduces video data, etc. connected to the hyperlink object selected by the user through the second input/output unit 200. The second input/output unit 200 also includes a bistable display element such as electronic paper, and thus has an advantage of reducing power consumption. However, the second input/output unit 200 also has a low frame rate, which is not as suitable for reproducing video. Thus, the first input/output unit 100 reproduces video content connected to a hyperlink object that is selected in the second input/output unit 200.

Also, when the content file subject to the link is not stored in the memory unit 400, the content file is downloaded from a server. Further, a communication unit 500 (FIG. 1) downloads the content subject to the link using the hyperlink object information corresponding to the user input. For instance, when a user input is received for the hyperlink object information which is underlined on a specific word, the communication unit 500 downloads the content subject to the link from a server by using the word as a keyword.

In addition, the communication unit 500 downloads the link object content from a server using a hyperlink object information corresponding to the user input. For instance, when receiving a user input to the hyperlink object information underlined on a specific word from the user, the communication unit 500 downloads the link object content from the server by using the word as a key word. Furthermore, when related information data of the multimedia content reproduced through the first input/output unit 100 is not stored in the memory unit 400, the communication unit 500 downloads the related information data from a server. In particular, the communication unit 500 downloads the related information data from a server by using information included in a header portion of the multimedia content file.

In addition, a main setting unit 600 (FIG. 1) can be used to set a main input/output unit in a portable electronic device according to an embodiment of the present invention. In particular, the main setting unit 600 sets either one of the first input/output unit 100 or the second input/output unit 200 as the main input/output unit, and sets the other one as the sub input/output unit. Further, when a reproduction command for multimedia content or electronic document is received from a user, the main input/output unit is an input/output unit outputting a main video signal corresponding to the reproduction command. In addition, when either one of the first input/output unit 100 or the second input/output unit 200 is set to the main input/output unit, the sub input/output unit is the other input/output unit, which is not set to the main input/output unit.

Further, a conversion unit 700 (FIG. 1) converts a touch screen of the sub input/output unit set by the main setting unit 600 into a touch pad for controlling the main input/output unit. For instance, when the first input/output unit 100 is set to the main input/output unit by the main setting unit 600, a touch screen of the second input/output unit 200 is converted into a touch pad for controlling the first input/output unit 100. In addition, the conversion unit 700 moves a cursor on the main input/output unit or scrolls a screen based on a touch input to the touch screen of the sub input/output unit. In addition, the cursor on the main input/output unit can be moved by corresponding to the touch input in a one-to-one manner.

For instance, when the first input/output unit 100 and the second input/output unit 200 are respectively provided in the front and rear sides of a main body of the portable electronic device according to one embodiment of the present invention, the units are set in such a way that points on a touch screen of the sub input/output unit respectively correspond to points by plane symmetry on the main input/output unit. In other words, an input to a specific position by the user on the sub input/output unit will be recognized as an input to a point corresponding to the specific position by plane symmetry on the main input/output unit. Furthermore, a cursor movement on the main input/output unit may be performed relatively based upon the touch input. For instance, a cursor on the main input/output unit is moved or a screen is scrolled based upon the relative position and speed of the user's input to a touch screen of the sub input/output unit.

Accordingly, there is an advantage that the user's convenience is promoted by receiving the reproduction of a screen through the main input/output unit while at the same time utilizing a touch screen of the sub input/output unit as a touch pad. Further, when only the second input/output unit 200 includes the touch screen and when the first input/output unit 100 is set as the main input/output unit, the touch screen of the second input/output unit 200 is converted into a touch pad for an input of the user's command.

In addition, in one embodiment of the present invention, a gravity sensor 610 of the main setting unit 600 can determine either one of the first input/output unit 100 and the second input/output unit 200 as the main input/output unit by sensing gravity. In other words, the main setting unit 600 sets an input/output unit formed on a surface which is sensed to face an opposite direction of gravity by the gravity sensor as a main input/output unit. For example, when the first input/output unit 100 and the second input/output unit 200 are respectively formed on the front and rear sides of the portable electronic device main body, the main setting unit 600 sets the input/output unit on a side facing an opposite direction of gravity as the main input/output unit by using gravity sensed through the gravity sensor 610.

For instance, when the first input/output unit 100 faces in a direction of gravity, the second input/output unit 200 is formed on the opposite side of the first input/output unit 100, and thus the main setting unit 600 sets the second input/output unit 200 facing an opposite direction of gravity as a main input/output unit. Furthermore, the conversion unit 700 converts a touch screen of the first input/output unit 100 into a touch pad controlling the second input/output unit 200. Therefore, a user can perform a touch input for controlling the second input/output unit 200 through the first touch panel 110.

In addition, an illuminance sensor 620 in the main setting unit 600 can determine either one of the first input/output unit 100 or the second input/output unit 200 as the main input/output unit by sensing illuminance. In other words, an input/output unit formed on a surface where the illuminance is sensed higher by the illuminance sensor is set as the main input/output unit. Further, when the first input/output unit 100 and the second input/output unit 200 are respectively formed on the front and rear sides of the portable electronic device main body, the main setting unit 600 sets the input/output unit on a side having a higher illuminance as the main input/output unit by using illumination sensed through the illuminance sensor 620.

For instance, when the first input/output unit 100 faces the ground, the second input/output unit 200 is formed on the opposite side of the first input/output unit 100, the illumination of the first input/output unit 100 facing the ground is relatively low. Therefore, the main setting unit 600 sets the second input/output unit 200, which has been sensed to have a relatively high illuminance, as the main input/output unit. Furthermore, the conversion unit 700 converts a touch screen of the first input/output unit 100 into a touch pad for controlling the second input/output unit 200. Therefore, a user can perform a touch input for controlling the second input/output unit 200 through the first touch panel 110.

Furthermore, a camera sensor 630 in the main setting unit 600 can determine either one of the first input/output unit 100 and the second input/output unit 200 as the main input/output unit by sensing the user. In other words, the main setting unit 600 sets an input/output unit formed on a surface which is sensed to face in a direction of the user as a main input/output unit. In addition, the camera sensor 630 can be formed on a side of the surfaces where the first input/output unit 100 and the second input/output unit 200 are formed. The camera sensor 630 is used by the setting unit 600 to set the input/output unit on a side facing the user as a main input/output unit by sensing the user's eyes or shape.

For instance, when a user is sensed by the camera sensor 630 formed on a side of the surface where the first input/output unit 100 is formed, the main setting unit 600 sets the first input/output unit 100 facing the user side as the main input/output unit. Furthermore, the conversion unit 700 converts a touch screen of the second input/output unit 200 into a touch pad for controlling the first input/output unit 100. Therefore, a user can perform a touch input controlling the first input/output unit 100 through the second touch pad 210. The main setting unit 600 can also include an infrared sensor, and set either one of the first input/output unit 100 and the second input/output unit 200 as the main input/output unit by sensing the user through the infrared sensor.

In another embodiment, a user input unit 650 (FIG. 1) can receive a user input for setting either one of the first input/output unit 100 and the second input/output unit 200 as the main input/output unit. Further, the main setting unit 600 sets either one of the first input/output unit 100 or the second input/output unit 200 as the main input/output unit based upon a user input received by the user input unit 650. In addition, the user input unit 650 may be constructed in a button form on a side of a portable electronic device according to an embodiment of the present invention. In addition, a user sets either one of the first input/output unit 100 or the second input/output unit 200 as the main input/output unit through an input to a button. For instance, when the first input/output unit 100 is set as the main input/output unit by a user's button manipulation, the conversion unit 700 converts a touch screen of the second input/output unit 200 into a touch pad for controlling the first input/output unit 100.

In addition, the touch screen is an input device in which points on a screen displayed through an input/output unit respectively correspond to points on the touch screen in a one-to-one manner, and an input through the touch screen is recognized as an input to a position on the screen corresponding to the relevant position. On the contrary, the touch pad is an input device for moving a cursor on the screen displayed on an input/output unit by receiving a touch input. That is, the touch pad is driven in a different way from the touch screen in that it is not driven by a method of corresponding to points on the screen displayed through an input/output unit in a one-to-one manner.

Furthermore, the user input unit 650 may be constructed in a form of touch input unit for receiving an input by the user's touch to a specific position of a portable electronic device according to an embodiment of the present invention. In addition, the user sets either one of the first input/output unit 100 or the second input/output unit 200 as the main input/output unit through a touch to the touch input unit. In addition, the touch input unit is formed at a position where the portable electronic device is grasped by a user to receive a touch input by a user. For example, the touch input unit can be formed at a position of the left and right sides of the portable electronic device where it can be grasped by a user. For instance, when the portable electronic device is grasped with a right hand by a user, the first input/output unit 100 formed on the front surface of the portable electronic device can be set as the main input/output unit by touching a touch input unit formed on the right side. Then, the conversion unit 700 converts a touch screen of the second input/output unit 200 into a touch pad for controlling the first input/output unit 100.

In addition, when a touch input unit formed on the left side is touched with a right hand by a user, the second input/output unit 200 formed on the rear side of the portable electronic device is set as the main input/output unit. Further, a touch screen of the first input/output unit 100 is converted into a touch pad for controlling the second input/output unit 200 by the conversion unit 700. In addition, the control unit 300 generates an idle screen information of the second input/output unit 200. Also, the idle screen information is the information constructing an idle screen displayed through the second input/output unit 200 in a state that the second input/output unit 200 enters an idle mode. For example, the idle screen information includes information on the remaining capacity of a battery and expected charge and discharge time, information on current time and user schedule, etc.

The idle screen information generated by the control unit 300 is also transmitted to the second controller 220 and displayed through the second input/output unit 200. Furthermore, the control unit 300 turns off the power applied to the second input/output unit 200 for a predetermined time period after an idle screen is displayed on the second input/output unit 200 by the second controller 220. This is to reduce power consumption by using the characteristic of the second input/output unit 200 provided with a bistable display element. In other words, the second input/output unit 200 maintains the final image as it is even when the external signal input has been removed, thereby turning off the power applied in a state that idle screen information is displayed, and reducing power consumption.

Furthermore, when the second input/output unit 200 enters an idle mode, the control unit 300 updates the idle screen information with a predetermined time period and transmits the information to the second controller 220. This is to provide changed information to the user after a predetermined time has passed, because an idle screen displayed through the second input/output unit 200 is in a state that the final image just before removing the external signal input is maintained. Accordingly, after updating the idle screen displayed through the second input/output unit 200, the control unit 300 turns off the power applied to the second input/output unit 200 once again, thereby minimizing power consumption.

In addition, the remaining capacity of a battery constituting the idle screen information is measured by a capacity calculation unit 800 (FIG. 1). Also, the capacity calculation unit 800 measures the remaining capacity of a battery to calculate the expected charge and discharge time. The control unit 300 also generates the idle screen information by using the remaining capacity of a battery through the capacity calculation unit 800 and the calculated expected charge and discharge time. Further, the control unit 300 displays the remaining capacity and the expected charge and discharge time with graphic images in a form of bar, scale, and diagram as well as along with time-unit designators in a form of number notation.

In addition, the current time and user schedule information constituting the idle screen information are provided by a timer unit 900 (FIG. 1) and the memory unit 400. In more detail, the timer unit 900 provides current time information, and the memory unit 400 stores schedule information established by a user. The control unit 300 also generates idle screen information by using the user schedule information stored in the memory unit 400 and the current time information provided by the timer unit 900. Further, the control unit 300 displays the current time along with the user schedule based on time.

In addition, when the main setting unit 600 sets either one of the first input/output unit 100 or the second input/output unit 200 as the main input/output unit, and sets the other one as the sub input/output unit, the control unit 300 determines that an input/output unit already set as a sub input/output unit by the main setting unit 600 enters an idle mode. Accordingly, when the first input/output unit 100 is set as the main input/output unit by the main setting unit 600, the second input/output unit 200 displays an idle screen.

Furthermore, when multimedia content is reproduced through the first input/output unit 100 according to the user's setting, the control unit 300 may determine that the second input/output unit 200 enters into an idle mode. At this time, when identifying the multimedia content reproduced through the first input/output unit 100, the control unit 300 generates idle screen information of the second input/output unit 200. In addition, the second controller 220 receives the idle screen information from the control unit 300 to display an idle screen on the second input/output unit 200

Moreover, when a power end signal is received by the control unit 300, the control unit 300 determines that the second input/output unit 200 enters into an idle mode. Further, the power end signal corresponds to a signal to end the main power of a portable electronic device according to an embodiment of the present invention. In other words, when the electrical capacity of a battery has been consumed, the control unit 300 receives the power end signal to generate the idle screen information of the second input/output unit 200. In addition, the second controller 220 receives the idle screen information from the control unit 300 to display an idle screen on the second input/output unit 200.

In addition, when the power end signal is received, the second input/output unit 200 to be entered into an idle mode means to display specific information through the second input/output unit 200 in a state of the idle mode. In other words, the second input/output unit 200 is provided with a bistable display element, and therefore, the unit 200 is continuously provided specific information by maintaining the final image for a specified period of time even when a signal ending the main power of the portable electronic device is received and the power application is cut off.

As a result, there is an advantage in the portable electronic device according to an embodiment of the present invention, because power consumption is reduced by displaying an idle screen through the input/output unit of an electronic paper, the current power state of the portable electronic device is seen by updating an idle screen with a specified time period, and the schedule management is possible based on a current time.

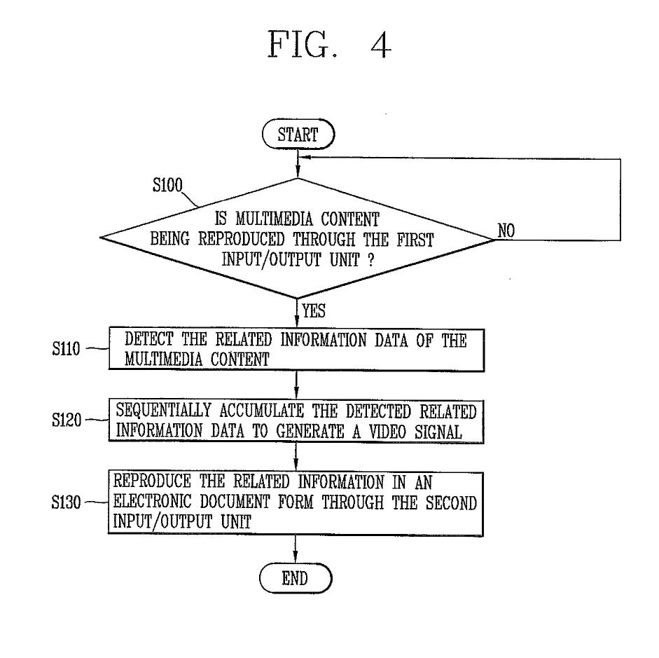

Next, FIG. 4 is a flow chart illustrating a method of reproducing content in a portable electronic device according to first embodiment of the present invention. As illustrated in FIG. 4, the method begins with determining whether or not the first input/output unit 100 is reproducing multimedia content (S100). Next, the related information data of the multimedia content is detected (S11). In addition, the step S110 is performed by the first input/output unit 100 when the first input/output unit 100 is reproducing multimedia content. On the contrary, the step S100 is performed again when the first input/output unit 100 is not reproducing multimedia content.

In addition, in this embodiment, the first input/output unit 100 and the second input/output unit 200 are respectively formed on the front and rear sides of the portable electronic device main body. Furthermore, the first input/output unit 100 includes an element for displaying a video signal having a relatively higher frame rate than that of the second input/output unit 200. In addition, the first input/output unit 100 includes a monostable display element, and the second input/output unit 200 includes a bistable display element. Moreover, the first input/output unit 100 includes a general display element (e.g., LCD), and the second input/output unit 200 includes an electronic paper display element. In particular, the electronic paper is a bistable display in which an image is maintained as it is when there is no external signal input, thereby having an advantage of consuming low power.

Next, and as discussed above, when the first input/output unit 100 is reproducing the multimedia content as a result of the determination (Yes in S100), the related information data of the multimedia content is detected (S110). Further, the related information data is detected using a file name of the multimedia content. For instance, the file name of the related information data can be identified by having the same file name as that of the multimedia content or by including some or all of the multimedia content file name.

Furthermore, if the multimedia content file is a music file, then the related information includes at least one or more of ID3 tag information, lyric information, and related article information. For instance, when a music is reproduced by the first input/output unit 100, information such as title, composer, singer, and the like, of the music is detected. In addition, information such as title, composer, and singer, etc. is detected from the song commentary information included in the ID3 tag information. Also, journal article information such as lyric information, music chart, broadcast appearance, etc. is displayed on the second input/output unit 200.

Furthermore, if the multimedia content file is a video file, then the related information includes at least one or more of subtitle information, film information, and related article information. For instance, when a film is reproduced by the first input/output unit 100, film information such as title, producer, actor or actress, synopsis, etc. of the film as well as subtitle information is detected, and the second input/output unit 200 displays the detected information. In addition, journal article information such as a film chart, number of audience, or the like is displayed on the second input/output unit 200.

Moreover, if the multimedia content file is an image file, then the related information includes at least one or more of EXIF (exchangeable image file format) information and user input information. For instance, when a photo is reproduced by the first input/output unit 100, EXIF information such as camera and lens information, capture date, exposure time, whether or not a flash is used, etc. of the photo is detected and displayed through the second input/output unit 200. In addition, user input information constructed with specific messages input from a user is displayed on the second input/output unit 200. Furthermore, the multimedia content file and the related information data of the multimedia content file are stored in a nonvolatile memory. The nonvolatile memory may be configured with any one of EEPROM, Flash Memory, PRAM, FRAM, and MRAM as stated above.

Subsequently, a video signal is generated by sequentially accumulating the detected related information data (S120). Here, sequentially accumulating the related information data means that the first input/output unit 100 sequentially reproduces a plurality of multimedia contents or records by accumulating from initially detected related information data to finally detected related information data in order to sequentially display those data when the related information data is constructed with a plural number and sequentially detected. For instance, if the multimedia content file is a music file, then information such as music lyrics and the like is detected from the non-volatile memory to generate a video signal for displaying on the second input/output unit 200, and at this time, the related information data is sequentially accumulated to sequentially display the information such as music lyrics and the like.

Next, the second input/output unit 200 reproduces the related information in a form of electronic document using the generated video signal (S130). Further, the related information generated through the second input/output unit 200 may be displayed on a page or sequentially displayed on a plurality of pages by constructing each page respectively. As a result, the related information of the multimedia content being reproduced through an input/output unit is displayed on the other input/output unit, thereby having an advantage that a user can receive the reproduction of multimedia content while at the same time receiving the related information.

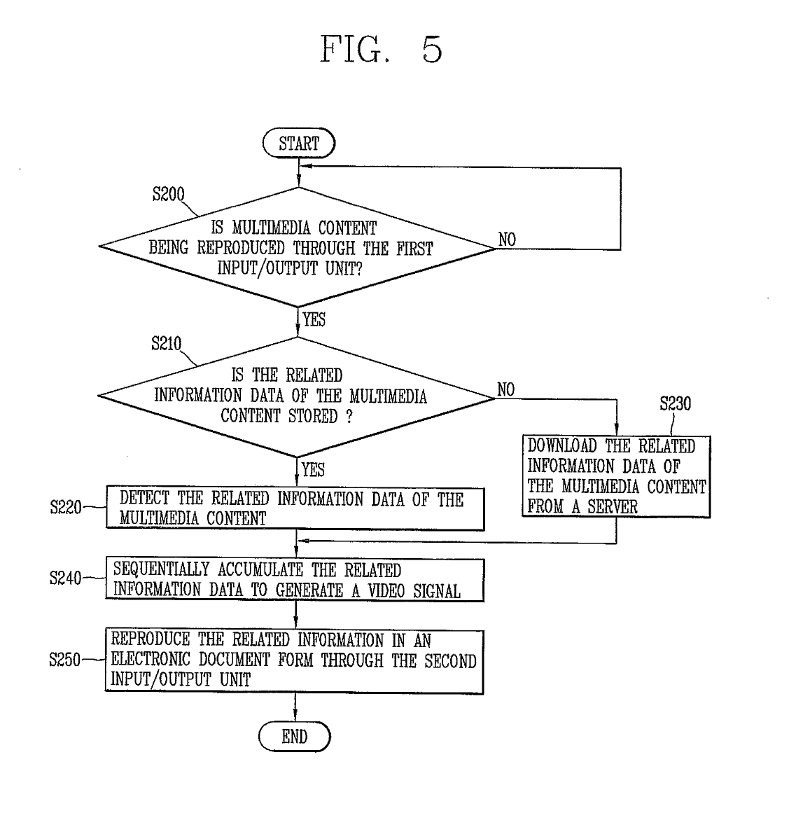

Next, FIG. 5 is a flow chart illustrating a method of reproducing content in a portable electronic device according to a second embodiment of the present invention. As illustrated in FIG. 5, the method begins with determining whether or not the first input/output unit 100 is reproducing multimedia content (S200). When the first input/output unit 100 is not reproducing the mutlimedia content (No in S200), the step S200 is repeated. When the first input/output unit 100 is reproducing the multimedia content as a result of the determination (Yes in S200), the method determines whether or not the related information data of the multimedia content is stored (S210).

When the related information data of the multimedia content is stored (Yes in S210), the related information data is detected (S220). In addition, as discussed above, the related information data is detected using a file name of the multimedia content. For instance, the file name of the related information data can be identified by having the same file name as that of the multimedia content or by including some or all of the multimedia content file name. On the other hand, when the related information data of the multimedia content is not stored (No in S210), the related information data is downloaded from a server (S230). That is, the related information data is downloaded from the server so the information can be displayed through the second input/output unit 200 when the related information data of the multimedia content does not exist among the data stored in the non-volatile memory.

Further, the download of the related information can be performed using information included in a header portion of the multimedia content file. In other words, information for identifying the related information of the multimedia content is included in the header portion of the multimedia content file, and the related information is retrieved and downloaded from the server using the information of the header portion. Next, a video signal is generated by sequentially accumulating the related information data detected at the step S220 or the related information data downloaded at the step S230 (S240). Here, sequentially accumulating the related information data to generate a video signal means that a plurality of multimedia contents are sequentially reproduced through the first input/output unit 100 or the related information data is sequentially displayed from initially detected related information data to finally detected related information data when the related information data is constructed with a plural number and sequentially detected.

Subsequently, the related information is displayed in a form of electronic document through the second input/output unit 200 using the generated video signal (S250). In addition, the related information generated through the second input/output unit 200 may be displayed on a page or sequentially displayed on a plurality of pages by constructing each page respectively as stated above. As a result, there is an advantage that when the related information of the multimedia content being reproduced is not stored, the information is downloaded from a server and provided to the user, thereby promoting the user's convenience.

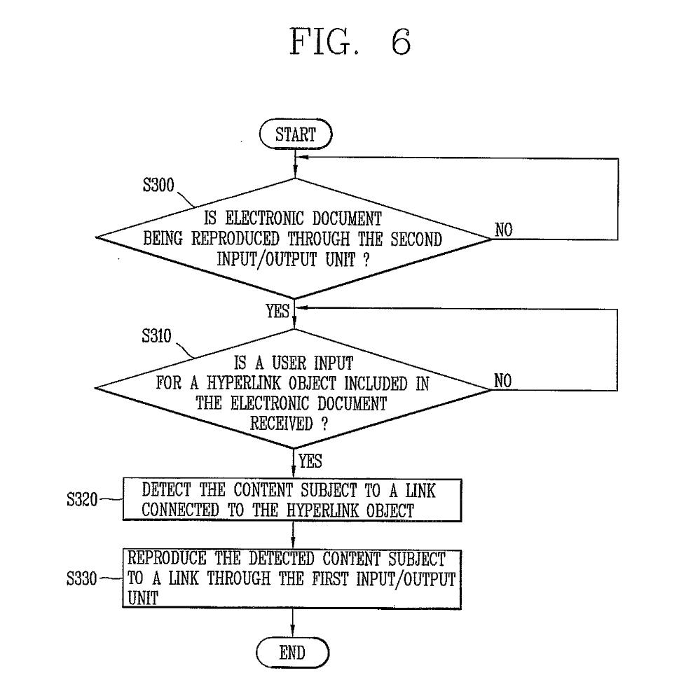

Next, FIG. 6 is a flow chart illustrating a method of reproducing content in a portable electronic device according to a third embodiment of the present invention. As illustrated in FIG. 6, the method begins with determining whether or not the second input/output unit 200 is reproducing an electronic document (S300). Further, the electronic document corresponds to data having a document format which is written, transmitted, received, or stored in an electronic form by an information processing system as stated above. In addition, the second input/output unit 200 may be formed on the opposite side of the first input/output unit 100 in a main body of the portable electronic device. In other words, the first input/output unit 100 and the second input/output unit 200 are respectively formed on the front and rear sides of the portable electronic device main body.

Furthermore, the first input/output unit 100 includes an element for displaying a video signal having a relatively higher frame rate than that of the second input/output unit 200. In addition, the first input/output unit 100 includes a monostable display element, and the second input/output unit 200 includes a bistable display element. Moreover, as discussed above, the first input/output unit 100 includes a general display element that is used in a portable electronic device, and the second input/output unit 200 includes an electronic paper display element.

Next, when the electronic document is being reproduced through the second input/output unit 200 (Yes in S300), the method determines whether or not a command for a hyperlink object included in the electronic document, that is, user input is received (S310). Further, the hyperlink means a function immediately showing the content selected by a user. Also, the hyperlink object means any one of text, image, background and an underline attribute included in the electronic document. For instance, when the user moves a mouse cursor having an arrow shape on any one of text, image, background and an underline attribute while reproducing the electronic document, the mouse cursor will be changed into a finger shape, for example, and at this time the user performs an input, thereby selecting the content subject to a link connected to the hyperlink object. The arrow or finger shape may also be replaced with another shape.

Subsequently, when the command is received (Yes in S310), the content subject to a link connected to the hyperlink object is detected (S320). Thus, the content subject to the link connected to the hyperlink object selected by the user is reproduced. Further, the content subject to a link means any one of text, image, audio and video contents connected by corresponding to the hyperlink object. Also, the content file subject to a link is stored in a nonvolatile memory, which may be configured with any one of EEPROM, Flash Memory, PRAM, FRAM, and MRAM as stated above. Next, the first input/output unit 100 reproduces the detected content subject to the link (S330). The purpose of this is to connect the multimedia content that is suitably reproduced through the first input/output unit 100 among the contents of the second input/output unit 200, in a form of hyperlink, by considering that the second input/output unit 200 includes a black and white screen such as an electronic paper, and includes an element displaying a video signal having a relatively lower frame rate than that of the first input/output unit 100, thereby promoting the user's convenience.

As a result, there is an advantage that the hyperlinked multimedia content can be reproduced through the first input/output unit 100 when a specific object is selected among the contents included in electronic document while reproducing the electronic document through the second input/output unit 200.

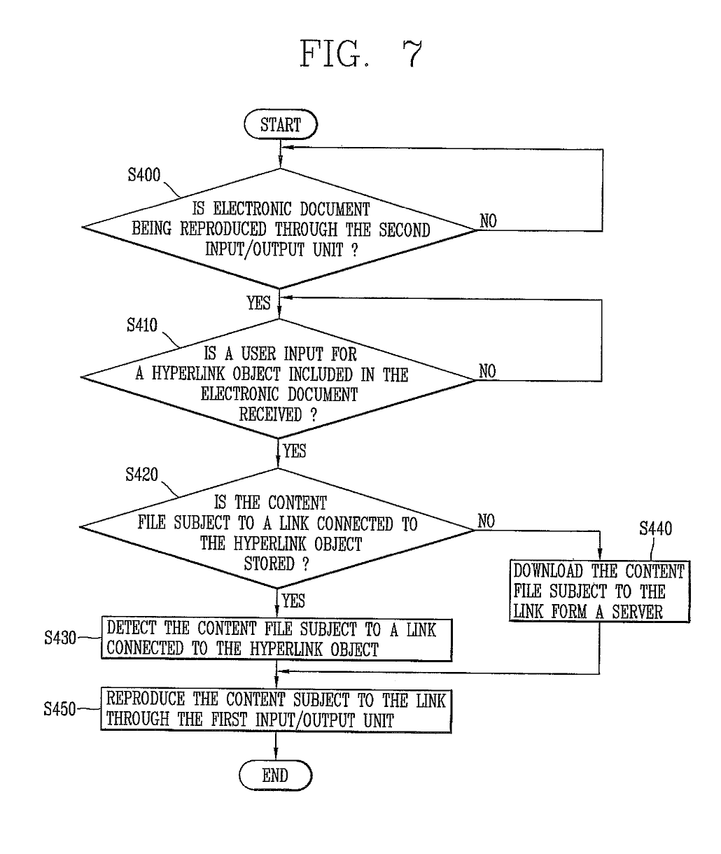

Next, FIG. 7 is a flow chart illustrating a method of reproducing content in a portable electronic device according to a fourth embodiment of the present invention. As illustrated in FIG. 7, the method begins with determining whether or not the second input/output unit 200 is reproducing an electronic document (S400). When the electronic document is being reproduced through the second input/output unit 200 (Yes in S400), the method determines whether or not a command for a hyperlink object included in the electronic document, that is, user input is received (S410). When the electronic document is not being reproduced through the second input/output unit 200 (No in S400), the method returns to step S400.

Subsequently, when the command, that is, user input is received as a result of the determination (Yes in S410), the method determines whether or not the multimedia content file subject to a link connected to the hyperlink object is stored (S420). When the command is not received (No in S410), the method returns to step S410. When the multimedia content file is stored (Yes in S420), the multimedia content file subject to a link connected to the hyperlink object is detected (S430). On the other hand, when the multimedia content file is not stored (No in S420), the multimedia content file subject to the link is downloaded from the server (S440).

Subsequently, the multimedia content file subject to the link is reproduced through the first input/output unit 100 (S450). Further, the multimedia content file subject to the link is the content connected to an object selected by the user among the hyperlink objects included in the electronic document being reproduced through the second input/output unit 200, and is reproduced with any one of text, image, audio and video contents.

As a result, there is an advantage that even when the multimedia content file connected to an hyperlink object selected by the user among the electronic document being reproduced is not stored in a portable electronic device, the content can be downloaded from a server and provided to the user, thereby more promoting the user's convenience.

Thus, according to a portable electronic device and a method of reproducing content thereof in accordance with embodiments of the present invention, the related information of the multimedia content being reproduced through an input/output unit is displayed through the other input/output unit, and thereby the user can receive the reproduction of multimedia content while at the same time receiving the related information. Furthermore, when the related information of the multimedia content being reproduced is not stored, it is downloaded from a server and provided to the user, thereby promoting the user's convenience.

In addition, when a specific object is selected among the contents included in electronic document while reproducing the electronic document through an input/output unit, the hyperlinked content for the selected object can be reproduced through the other input/output unit, thereby promoting the user's convenience. Moreover, even when the multimedia content file connected to an hyperlink object selected by the user among the contents of electronic document being reproduced through an input/output unit is not stored in a portable electronic device, the content can be downloaded from a server and provided to the user through the other input/output unit.

Further, the reproduction of multimedia content does not have to be suspended to retrieve related information, and the detailed information on the multimedia content can be received from a server when the related information is not stored in the portable electronic device.

In addition, the units 610, 620, 630 and 650 in FIG. 1 can be turned on/off, giving priorities, etc. For example, the gravity sensor 610 can be assigned a highest priority such that the gravity sensor 610 determines whether the first or second input/output unit is selected as the main unit over the other units 620, 630 and 650. Thus, if all units 610, 620, 630 and 650 indicates signals to select a particular input/output unit, a highest priority signal would be used in determining the main input/output unit. Also, if multiple signals were output by the units, the control unit 300 could provide a menu display or other output to select one of the multiple signals to determine which unit 610, 620, 630 and 650 would be used in determining the main input/output unit.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A portable electronic device, comprising:
a first input/output unit including a monostable display element and configured to reproduce multimedia content;
a second input/output unit including a bistable display element and configured to reproduce an electronic document;
a first controller configured to control the first input/output unit;
a second controller configured to control the second input/output unit;
a memory unit configured to store the multimedia content and the electronic document; and
a control unit configured to selectively control the first controller to reproduce the multimedia content on the first input/output unit, and to control the second input/output unit to reproduce the electronic document on the second input/output unit.

2. The portable electronic device of claim 1, wherein the first and second input/output units are respectively formed on front and rear sides of a main body of the portable electronic device.

3. The portable electronic device of claim 1, wherein the second controller is further configured to receive a command indicating a selection of a hyperlink object included in the electronic document being reproduced on the second input/output unit, and the control unit is further configured to detect additional multimedia content subject to a link connected with the hyperlink object from the memory unit and to control the first controller to reproduce the additional multimedia content on the first input/output unit.

4. The portable electronic device of claim 3, wherein when the controller does not detect the additional multimedia content in the memory unit, the controller is further configured to control a communication unit to download the additional multimedia content from an external server.

5. The portable electronic device of claim 1, wherein while the first input/output unit is reproducing the multimedia content, the control unit is further configured to detect electronic document information data related to the multimedia content from the memory unit and to control the second controller to reproduce the detected electronic document information data on the second input/output unit.

6. The portable electronic device of claim 5, wherein when the control unit does not detect the electronic document information data in the memory unit, the controller is further configured to control a communication unit to download the electronic document information data from an external server.

7. The portable electronic device of claim 5, wherein the second controller is further configured to transmit a video signal generated by sequentially accumulating the electronic document information data received from the control unit to the second input/output unit.

8. The portable electronic device of claim 1, wherein the first and second input/output units respectively include first and second display elements for displaying a video signal having different frame rates from each other.

9. The portable electronic device of claim 8, wherein the first display element displays a video signal having a higher frame rate than the second display element.

10. The portable electronic device of claim 1, wherein the second controller is further configured to convert a touch screen of the second input/output unit into a touch pad and to apply touch signals to the touch pad to the first input/output unit such that the touch signals on the touch pad of the second input/output unit control the first input/output unit.

11. A method of controlling a portable electronic device, the method comprising:
controlling, via a first controller, a first input/output unit including a monostable display element for reproducing multimedia content;
controlling, via a second controller, a second input/output unit including a bistable display element for reproducing an electronic document;
storing the multimedia content and the electronic document in a memory unit of the portable electronic device; and
selectively controlling, via a control unit, the first controller to reproduce the multimedia content on the first input/output unit and the second input/output unit to reproduce the electronic document on the second input/output unit.

12. The method of claim 11, wherein the first and second input/output units are respectively formed on front and rear sides of a main body of the portable electronic device.

13. The method of claim 11, further comprising:
receiving, via the second controller, a command indicating a selection of a hyperlink object included in the electronic document being reproduced on the second input/output unit;
detecting, via the control unit, additional multimedia content subject to a link connected with the hyperlink object from the memory unit; and
controlling, via the control unit, the first controller to reproduce the additional multimedia content on the first input/output unit.

14. The method of claim 13, further comprising:
downloading, via a communication unit, the additional multimedia content from an external server, when the detecting step does not detect the additional multimedia content in the memory unit.

15. The method of claim 11, further comprising:
detecting, via the control unit, electronic document information data related to the multimedia content from the memory unit, while the first input/output unit is reproducing the multimedia content; and
controlling, via the control unit, the second controller to reproduce the detected electronic document information data on the second input/output unit.

16. The method of claim 15, further comprising:
downloading, via a communication unit, the electronic document information data from an external server, when the control unit does not detect the electronic document information data in the memory unit.

17. The method of claim 15, further comprising:
transmitting, via the second controller, a video signal generated by sequentially accumulating the electronic document information data received from the control unit to the second input/output unit.

18. The method of claim 11, wherein the first and second input/output units respectively include first and second display elements for displaying a video signal having different frame rates from each other.

19. The method of claim 18, wherein the first display element displays a video signal having a higher frame rate than the second display element.

20. The method of claim 11,further comprising:
converting, via the second controller, a touch screen of the second input/output unit into a touch pad; and
applying touch signals to the touch pad to the first input/output unit such that the touch signals on the touch pad of the second input/output unit control the first input/output unit.
